(19) United States
(12) Patent Application Publication
(10) Pub. No.: US 2014/0013224 A1
(43) Pub. Date: Jan. 9, 2014

(54) AUDIO SYSTEM AND AUDIO SYSTEM LIBRARY MANAGEMENT METHOD

(71) Applicants: Alastair Brown, Glasgow (GB); Martin Dalgleish, Glasgow (GB)

(72) Inventors: Alastair Brown, Glasgow (GB); Martin Dalgleish, Glasgow (GB)

(73) Assignee: SIMPLE AUDIO LTD, Glasgow (GB)

(21) Appl. No.: 13/544,947

(22) Filed: Jul. 9, 2012

(51) Int. Cl. G06F 15/16; G06F 17/30; G06F 3/01

(52) U.S. Cl. 715/716

(57) ABSTRACT

An audio system is provided, the audio system comprising one or more user devices connected to a network having at least one audio amplifier and associated loudspeakers. The one or more user devices may comprise memory holding a plurality of libraries of audio items in digital form, each library being associated with a particular user. The one or more user devices may also comprise means for compiling a database of information relating to the audio items in each library. The database of each library may be available to any user, and selection of an item from a database causes the item to be played from the library in which the audio data is held.

### BACKGROUND

It is common to have an audio system in which music is stored in digital form in one or more libraries in a computer or similar device. Such systems may also comprise one or more audio amplifiers and one or more sets of loudspeakers.

Where there is a multi-user system, there is the possibility of allowing each user to access all the music on the system. This could be done by forming a single combined library. However, such an arrangement would have drawbacks. It would be necessary for one user, or one computer in a multi-computer system, to hold and administer the library, and to have some arrangement for adding items to and removing items from the library. In addition, some users may have no interest in the type of music preferred by others, and would prefer not to have to see those items displayed as being available for play.

It is therefore an object of the present invention to provide a multi-user library management system which is at least one of: (1) dynamic, in that it updates as users' libraries alter, (2) selective, in that it allows users to control the range of choice available to them, and (3) interactive, in that it allows the various users to access all material on the system.

### SUMMARY

In one embodiment, an audio system is provided, the audio system comprising: one or more user devices connected to a network having at least one audio amplifier and at least one loudspeaker, wherein the one or more user devices comprise: memory, containing: a first library of audio items in digital form, wherein the first library is associated with a first user; a second library of audio items in digital form, wherein the second library is associated with a second user; a first database corresponding to the first library, wherein the first database contains information relating to the audio items of the first library; and a second database corresponding to the second library, wherein the second database contains information relating to the audio items of the second library; wherein the first database is available to the second user and the second database is available to the first user; and wherein selection of an audio item from the first database causes the audio item to be played from the first library and wherein selection of an audio item from the second database causes the audio item to be played from the second library.

In another embodiment, a method for managing libraries of audio items is provided, the method comprising: providing one or more user devices connected to a network having at least one audio amplifier and at least one loudspeaker, wherein the one or more user devices comprise: a first library of audio items in digital form, wherein the first library is associated with a first user; a second library of audio items in digital form, wherein the second library is associated with a second user; a first database corresponding to the first library, wherein the first database contains information relating to the audio items of the first library; and a second database corresponding to the second library, wherein the second database contains information relating to the audio items of the second library; enabling the selection of an audio item from the first database to cause the audio item to be played from the first library and enabling the selection of an audio item from the second database to cause the audio item to be played from the second library.

Embodiments of the invention will now be described, by way of example only, with reference to the drawings.

### BRIEF DESCRIPTION OF THE DRAWINGS

The accompanying figures, which are incorporated in and constitute a part of the specification, illustrate various example apparatuses, systems, and methods, and are used merely to illustrate various example embodiments.

FIG. 1 is a schematic overview of a multi-user, multi-room audio system;

FIG. 2 shows an on-screen list of available libraries;

FIG. 3 shows a screen display for managing users;

FIG. 4 shows an on-screen display for choosing musical items to be played; and

FIG. 5 is a flowchart illustrating a method for utilizing a network of user devices for playing music.

### DETAILED DESCRIPTION

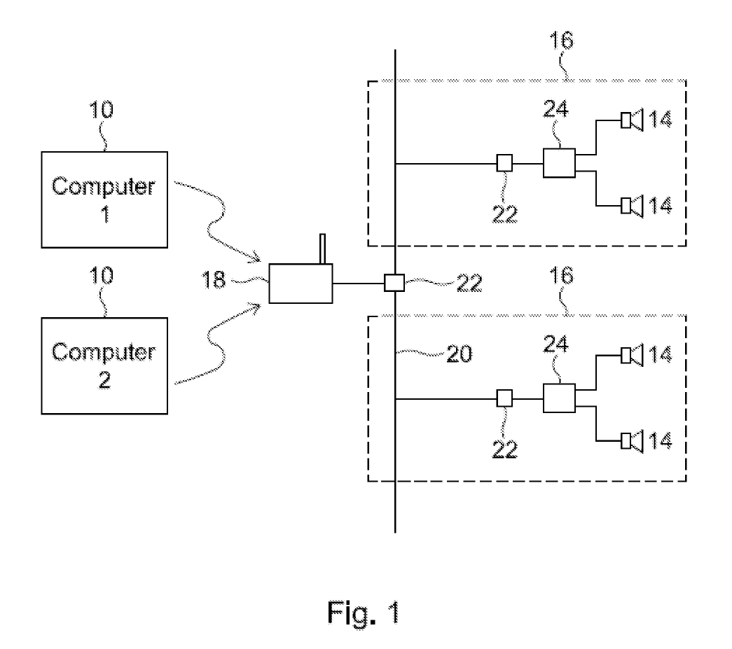

Referring to FIG. 1, an audio system comprises two or more computers 10 and two or more loudspeakers 14 capable of playing audio in respective rooms 16. The system further comprises a wireless router 18, a main power supply wiring system 20, and adaptors 22. Each of rooms 16 may further comprise a room module 24. In one embodiment, the audio system comprises two or more computers 10, and two or more room modules 24 in respective rooms 16. The computers 10 may communicate with a wireless router 18, which in turn may communicate with the room modules by means of Ethernet-over-power using the main power supply wiring system 20 of the building and adaptors 22. Each room module 24 may comprise a decoder and an audio amplifier driving loudspeakers 14. The system shown exemplifies a Simple Audio™ system, in which one computer 10 is designated as a control computer and one room module 24 is designated as a master module. In one embodiment, the room modules 24 each have an integral adaptor 22.

In one embodiment, an audio system is provided, the audio system comprising: one or more user devices connected to a network having at least one audio amplifier and associated loudspeakers; the one or more user devices comprising memory holding a plurality of libraries of audio items in digital form, each library being associated with a particular user, and means for compiling a database of the audio items in each library; and in which the database of each library is available to any user, and selection of an item from a database causes the item to be played from the library in which the audio data is held.

The foregoing are examples only of an audio system to which the invention may be applied. Other forms of network may equally be used, such as wireless networks and those using dedicated hard wiring. In one embodiment, the network may be a multi-room audio system, in which the selected item can be played in a selected room of the system.

In one embodiment, the audio items comprise a block of digital data, such as an audio file. The audio items may comprise audio files in any of various file formats, including but not limited to, MP3, AAC, WAV, AIFF, FLAC, and Apple Lossless.

In one embodiment, each of the computers 10 has at least one music library. Typically, a computer 10 may have a single library which is personal to the user of that computer. The library may be held in any suitable format such as an iTunes library, a Windows Media Player library, or any other folder-based library. In another embodiment, the invention comprises plural user devices each of which holds a respective library. In one embodiment, the library is a collection of audio items, wherein the audio items may comprise a block of digital data.

In one embodiment, each computer 10 can search for libraries on the system. The search may be initiated by a user command, or the computer can be programmed to search automatically, for example when first connected to the system or at regular intervals. Any library which is not found automatically may be navigated to in the same way as any other file or folder.

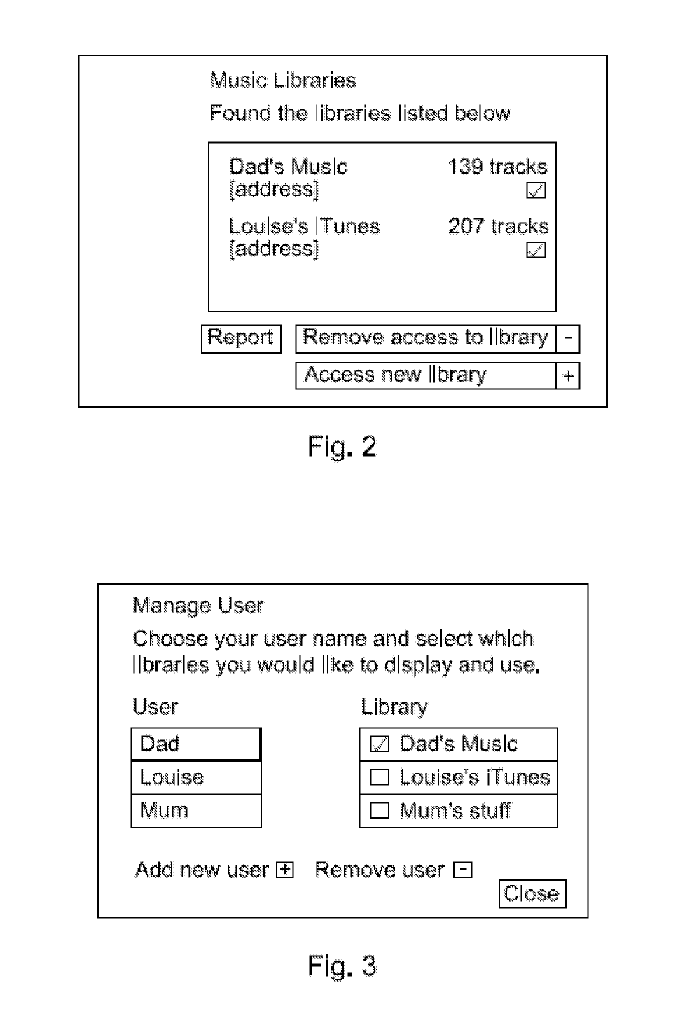

In one embodiment, the search produces an on-screen list of available libraries, such as that shown in FIG. 2. The user may select libraries for which the user wishes to create a database. A user command may then index each of the selected libraries to create a corresponding database for each chosen library.

In one embodiment, a database may be created for any chosen library. The database may comprise a collection of information gleaned from the metadata of the audio items contained in a given library. In another embodiment, the database includes the album name, track name, running time, and artwork of one or more audio items contained in a library. In one embodiment, the database is essentially a list of the audio items contained in a particular library, and the database does not contain actual audio items but rather simply contains information about the audio items in a library.

A user may then personalize which libraries (through a corresponding database for that library) the user wishes to be normally available to the user. A “manage user” routine, as illustrated in FIG. 3, may allow the user to select these libraries by ticking relevant boxes; in this way the user may ignore libraries which are not likely to be of interest to the user.

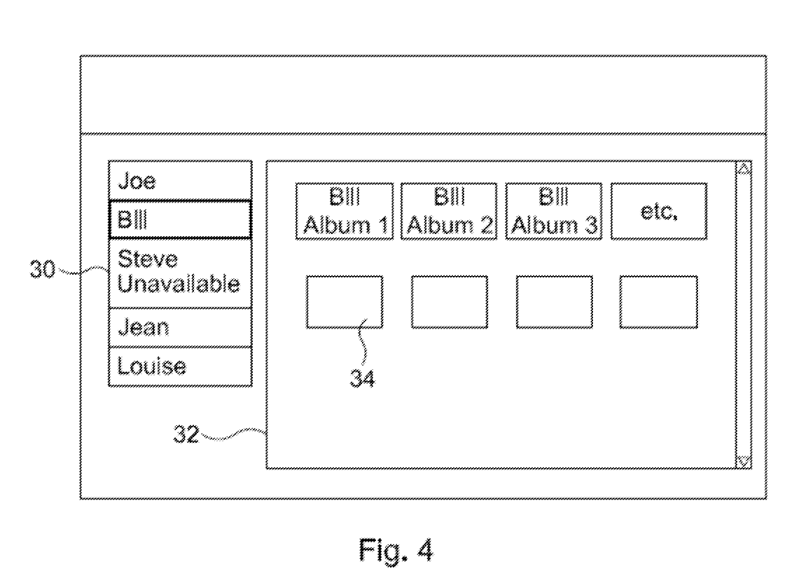

When the user of a particular computer wishes to play music, a listing may be displayed as in FIG. 4. In one embodiment, the area 30 contains a list of available and selected libraries; by clicking on one of these, the database containing the contents of that library may be displayed in the area 32. The contents may be displayed as a series of pictorial images 34 with titles. The user may then click on a chosen item to be played in a selected room. In one embodiment, each user device comprises a display on which a list of libraries available can be displayed and user input means for selecting such libraries to be displayed or not displayed on that user device. In one embodiment, when a user of a first computer/user device desires to listen to a track contained in the library of a second computer/user device, the user will select the item from the second computer/user device's library database (which is displayed on the first computer/user device), which will cause the audio item to play from the second computer/user device to the first computer/user device.

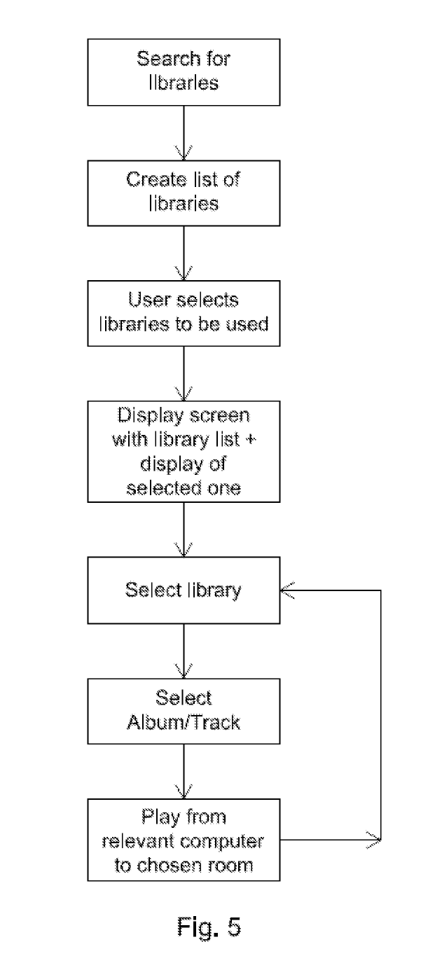

In one embodiment, a method is provided as illustrated in FIG. 5. The method may include the steps of (1) searching for libraries; (2) creating a list of libraries; (3) selecting libraries to be used; (4) displaying library list and selected libraries; (5) selecting library; (6) selecting album/track to be played; and (7) playing the track from the relevant computer to the chosen room. As additionally illustrated in FIG. 5, the method may additionally include repetition of steps 5-7. In one embodiment, step 6 may include creating a database for the library selected in step 3, the database including information regarding the album/track to be played.

In one embodiment of the invention, any given computer will acquire and store a copy of the database for the library of all other computers at the time when they are selected and at intervals thereafter, as opposed to acquiring the database when the user wishes to see the database for a given library. This allows all material on the system to be reviewed quickly.

It is important to note that this arrangement does not move, copy or change any music. The only data that moves between one computer and another are files of databases for the one or more libraries. The music itself remains untouched on the computer where it was originally stored (in that computer's library) and, if the user chooses to play a musical item from another computer, the music data is sent from that other computer to the selected room module. Thus a user cannot alter or degrade another user's library.

In one embodiment, there will be occasions when a given computer is powered off or is physically absent from the network. To deal with this, one embodiment provides a time-out arrangement, in which each computer will search for the presence of all other computers holding selected libraries at regular intervals. If a given computer is missing from the network, the library on that computer may be shown as “unavailable” on the list of libraries in FIG. 3. However, as soon as that computer re-joins the network and is identified, its library may re-appear on the other computers and they may still have the previously stored database information ready for display. In one embodiment, a library associated with a given user device is shown as unavailable in the list of libraries on other user devices if the given user device is absent from the network for a given length of time.

The foregoing description is based on each user being associated with each user's own computer. However, this is not essential to the principle of the invention. In one embodiment, what is necessary is that each library is associated with a given user and thus, for example, two users could share one computer which would hold two libraries. Indeed, the invention can equally be used in a system which comprises a single computer operating in a single room, but with two or more users each having a distinct library.

The audio system of FIG. 1 may also be used with streaming services such as We7™ and Deezer™. In one embodiment, the user of each computer 10 will be registered as a user with the streaming service. In another embodiment of the present invention, any user connected to the audio system can access streaming services by logging in as any user on the system. In this way, streaming services may be used as another set of multiple libraries. In one embodiment, to enable this mode of operation, user credentials for all users are automatically stored and swapped. In one embodiment, each user device may additionally display a list of streaming services used by other user devices and can access a streaming service using credentials held on the appropriate other user device, and may additionally display a list of radio services used by other user devices.

The system of FIG. 1 may also be used in conjunction with Internet radio services. Each user may create a list of radio stations, and each user's list is available to all other users. This may be done as with the user audio libraries, with each computer is automatically searching for and copying radio station lists from the other computers. In another embodiment, radio station lists are stored on a master room module where they can be accessed as required by all users.

Modifications and improvements may be made to the foregoing embodiment within the scope of the invention.

The invention has been described with reference to one or more user computers or user devices. Typically, each computer or user device will be a laptop or PC. However, other forms of computer or user device may be used, such as tablets, and the terms “computer” and “user device” is used herein to encompass any electronic device with suitable processing, memory and display functions, including game boxes, smart phones, portable music players, and the like.

In one embodiment, it is possible to control operation remotely from the computer being used, for example by using a conventional remote control device which communicates with a room module.

In the case of a multi-room system, the invention is not limited to Ethernet-over-power systems, but is equally applicable to other multi-room audio systems for example using dedicated hard wiring.

The present invention thus provides a flexible and dynamic system for accessing and using multiple audio libraries in a multi-user audio system.

In one embodiment, computer-readable media, including music files, databases, and libraries, are non-transitory computer-readable media. Non-transitory computer-readable media may comprise all computer-readable media except for transitory propagating signals.

Other modifications may be made to the foregoing embodiments within the scope of the invention.

To the extent that the term “includes” or “including” is used in the specification or the claims, it is intended to be inclusive in a manner similar to the term “comprising” as that term is interpreted when employed as a transitional word in a claim. To the extent that the term “or” is employed (e.g., A or B), it is intended to mean “A or B or both.” When the applicants intend to indicate “only A or B but not both,” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

What is claimed is:

1. An audio system comprising:
one or more user devices connected to a network having at least one audio amplifier and at least one loudspeaker,
wherein the one or more user devices comprise:
memory, containing: a first library of audio items in digital form, wherein the first library is associated with a first user; a second library of audio items in digital form, wherein the second library is associated with a second user;
a first database corresponding to the first library, wherein the first database contains information relating to the audio items of the first library; and
a second database corresponding to the second library, wherein the second database contains information relating to the audio items of the second library;
wherein the first database is available to the second user and the second database is available to the first user; and
wherein selection of an audio item from the first database causes the audio item to be played from the first library and wherein selection of an audio item from the second database causes the audio item to be played from the second library.

2. The audio system of claim 1, wherein the one or more user devices comprise a first user device and a second user device, and wherein the first user device comprises the first library and the second user device comprises the second library.

3. The audio system of claim 1, wherein the network is a multi-room audio system comprising one or more rooms, and wherein the selection of an audio item causes the audio item to be played in the one or more rooms.

4. The audio system of claim 1, wherein each of the one or more user devices comprises:
a display on which is displayed one or more of the first library and the second library; and
a user input apparatus configured for selecting one or more of the first library and the second library to be displayed.

5. The audio system of claim 2, wherein the first library is unavailable when the first user device is absent from the network for a given length of time, and wherein the second library is unavailable when the second user device is absent from the network for a given length of time.

6. The audio system of claim 1, wherein one or both of the first library and the second library comprise a list of streaming services, wherein the list of streaming services is available to either of the first user and the second user, and wherein either of the first user and second user can access the streaming services using a credential contained on at least one of the one or more user devices.

7. The audio system of claim 1, wherein one or both of the first library and the second library comprise a list of radio services, wherein the list of radio services is available to either of the first user and the second user.

8. A method for managing libraries of audio items, comprising:
providing one or more user devices connected to a network having at least one audio amplifier and at least one loudspeaker,
wherein the one or more user devices comprise:
a first library of audio items in digital form, wherein the first library is associated with a first user; a second library of audio items in digital form, wherein the second library is associated with a second user;
a first database corresponding to the first library, wherein the first database contains information relating to the audio items of the first library; and
a second database corresponding to the second library, wherein the second database contains information relating to the audio items of the second library;
enabling the selection of an audio item from the first database to cause the audio item to be played from the first library and enabling the selection of an audio item from the second database to cause the audio item to be played from the second library.

9. The method of claim 8, wherein:
the one or more user devices comprise a first user device and a second user device;
the first user device comprises the first library;
the second user device comprises the second library;
causing the audio item to be played from the first library comprises causing the audio item to be played from the first user device; and
causing the audio item to be played from the second library comprises causing the audio item to be played from the second user device.

10. The method of claim 8, wherein the network is a multi-room audio system comprising one or more rooms, and wherein the selection of an audio item causes the audio item to be played in the one or more rooms.

11. The method of claim 8, wherein the one or more user devices selectively display at least one of the first library and second library, and wherein at least one of the first user and second user can select the display of at least one of the first library and second library on the one or more user devices.

12. The method of claim 9, wherein the first library is unavailable when the first user device is absent from the network for a given length of time, and wherein the second library is unavailable when the second user device is absent from the network for a given length of time.

13. The method of claim 8, wherein one or both of the first library and the second library comprise a list of streaming services, wherein the list of streaming services is available to either of the first user and the second user, and wherein either of the first user and second user can access the streaming services using a credential contained on at least one of the one or more user devices.

14. The method of claim 8, wherein one or both of the first library and the second library comprise a list of radio services, wherein the list of radio services is available to either of the first user and the second user.
